(19) United States
(12) Patent Application Publication
(10) Pub. No.: US 2024/0169362 A1
(43) Pub. Date: May 23, 2024

(54) METHOD AND SYSTEM FOR PROVIDING SMART CALLING PLATFORM

(71) Applicants: Rajender Kumar Nangia, OH, OH (US); Satyam Nangia, OH, OH (US)

(72) Inventors: Rajender Kumar Nangia, OH, OH (US); Satyam Nangia, OH, OH (US)

(21) Appl. No.: 18/552,448

(22) PCT Filed: Mar. 26, 2022
(86) PCT No.: PCT/IN2022/050306

§ 371 Date: Sep. 26, 2023

(30) Foreign Application Priority Data
Mar. 27, 2021 (IN) 202111013636

(51) Int. Cl. G06Q 30/015; G06Q 30/0282; H04W 12/06

(52) U.S. Cl. CPC G06Q 30/015; G06Q 30/0282; H04W 12/06

(57) ABSTRACT

Various aspects of a system and method for providing a smart calling platform (104) for managing sales leads, are disclosed herein. The method includes uploading, on a smart calling platform (104), a list having details of the executives enrolled with the business owner (102) with the intent of offering services on the smart calling platform (104). A unique identification is allocated to each of the executives for providing authenticated access of the platform. One or more potential customers (114) are allocated to each of the executives based on AI based correlation between business data associated with each of the one or more customers (114) and profile data of each of the executives. Generation of sales leads by each executive is monitored, and business transaction associated with the generated sales leads is managed based on the monitoring by storing the generated sales leads and tracking maturity thereof using a maturity score.

### FIELD OF THE DISCLOSURE

The present disclosure generally relates to the field of providing calling platform, and in particular, the present disclosure relates to method and system for providing smart calling platform for management of sales leads.

### BACKGROUND OF THE DISCLOSURE

With increasing penetration of telecom and telecom-supported facilities, the reliance of businesses on telecom and telecom-enabled technologies has increased manifolds. In particular, the telecom-based solutions now account for a major source enabling business expansion, running, and maintenance. In one particular illustration, tele-calling may be used for business development. Typically, in such an application area of tele-calling, a business owner generates a list of potential customers (callees) and deputes a plurality of tele-callers for calling the customers. Such plurality of tele-callers are armed with knowledge of the solution offered by the business and the skill for gathering and assessing customer's requirements. Owing to the nature of the field, the businesses often employ tele-calling executives on a part-time or contractual basis wherein the employees are required to dedicate only a portion of their time towards meeting the target. In other words, the tele-calling executives work part-time for a set duration while carrying on with their usual vocations in the remaining time. This helps the businesses to skimp on the investment required for operations and logistics as the tele-calling executives can often work from a remote location.

According to the prevailing laws on privacy, businesses handling personally identifiable information (PII) of customers are required to take explicit consent from the customers and are mandated by law to protect the privacy of such information. This involves taking necessary steps to ensure the security of the PII information held by the individual companies. In the tele-calling ecosystem discussed above, there is little that a business owner can do in terms of protecting customer PII in case the tele-calling executive decides to use the customers' PII for personal use. In certain scenarios, when the tele-calling executives provide their services for plurality of business owners, there is a risk of cross-pollination of sensitive PII data owned by one business owner to other(s). In certain other scenarios, a tele-calling executive working from a remote location may utilize a personal device for generating business leads. However, allowing unrestricted access to PH data to the tele-calling executive on their personal devices may mandate regulating the usage of personal device by the tele-calling executive. In the event of not doing so, it may lead to violation of a jurisdictional privacy law.

Another shortcoming of the existing tele-calling systems is that they do not allow communication between the tele-calling executive and the customers that originates from the customers' end. In other words, in case a sales lead starts to mature and the customer intends to contact the tele-calling executive for additional information or confirmation, the existing system fall short of providing an efficient solution. This is especially complex in case the correspondence between the tele-calling executives and the customers includes exchange of multimedia content.

In another scenario, it is often necessary for the business owner to track the progress of the sales leads generated by the tele-calling executives. However, the current systems rely on the information fed by the tele-calling executives to the business owners regarding the progress of the sales leads. Often, this leaves chance for the tele-callers to feed incorrect information to the business owners, who end up compensating the tele-calling executives, inspire of not realising any business outcome. From the point of view of the tele-calling executives, there are occasions where the tele-calling executives put in substantial amount of time and effort but the trail goes cold at the penultimate steps where the sales leads could have been translated into actual business. In such scenarios, it becomes difficult for the tele-calling executives to provide objective data to the business owners that reflects the amount of efforts put by the tele-calling executives and accordingly, the tele-calling executives may then run the risk of missing compensation for the effort, which was put by them for driving a sales lead.

In light of the above, there is a pressing need for having a platform that provides a secure way for facilitating correspondence between the tele-calling executive and the potential customers. The solution should also enable tracking progress of sales lead generation and its maturity while enhancing transparency between the business owners and the tele-calling executives. Further, the solution should be such that does not intrude the privacy of the tele-calling executives or the potential customers while providing maximum protection for the PII data and compliance in accordance with the prevailing privacy law in a geography.

### SUMMARY OF THE DISCLOSURE

The foregoing summary is illustrative only and is not intended to be in any way limiting. In addition to the illustrative aspects, embodiments, and features described above, further aspects, embodiments, and features will become apparent by reference to the drawings and the following detailed description.

In one embodiment, method of providing smart calling platform for management of sales leads as shown in, and/or described in connection with, at least one of the figures, as set forth more completely in the description below. The method includes, uploading, on a smart calling platform, a list of a plurality of executives by a business owner registered with the smart calling platform. The list includes details of the plurality of users that are enrolled with the business owner with the intent of offering services. The method further includes allocating, by the smart calling platform, a unique identification to each of the plurality of executives for providing authenticated access of the smart calling platform to each of the plurality of executives. The method further includes, allocating, by the smart calling platform, one or more potential customers to each of the plurality of executives, wherein the one or more potential customers are allocated from a list of potential customers uploaded on the smart calling platform by the business owner. The allocation of the one or more potential customers may be based on an artificial intelligence (AI) based correlation between business data associated with each of the one or more customers and profile data of each of the plurality of executives. The method further includes monitoring, by the smart calling platform, one or more activities of each of the plurality of executives. The activities include generation of sales leads by the plurality of executives. The method further includes managing, by the smart calling platform, business transaction associated with the generated sales leads based on the monitoring. The management includes storing the generated sales leads and tracking maturity thereof using a maturity score.

In another embodiment, a system for providing smart calling platform for management of sales leads as shown in, and/or described in connection with, at least one of the figures, as set forth more completely in the description below. The system includes a business owner registered with the platform, a plurality of executives for generation of sales leads for the business owner, wherein for managing the generated sales leads. The smart calling platform enables the business owner to upload a list of a plurality of executives registered with the smart calling platform. The list includes details of the plurality of users that are enrolled with the business owner with the intent of offering services. The platform further enable the business owner to allocate a unique identification to each of the plurality of executives for providing authenticated access of the smart calling platform to each of the plurality of executives. The platform further enable the business owner to allocate one or more potential customers to each of the plurality of executives. The one or more potential customers are allocated from a list of potential customers uploaded on the smart calling platform by the business owner. The allocation of the one or more potential customers may be based on an artificial intelligence (AI) based correlation between business data associated with each of the one or more customers and profile data of each of the plurality of executives. The platform further enable the business owner to monitor one or more activities of each of the plurality of executives. The activities include generation of sales leads by the plurality of executives. The platform further enable the business owner to manage business transaction associated with the generated sales leads based on the monitoring. The management includes storing the generated sales leads and tracking maturity thereof using a maturity score.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

This disclosure will be more fully understood from the following detailed description taken in conjunction with the accompanying drawings, in which:

FIG. 1 illustrates an exemplary environment in which various embodiments of the present disclosure can be practiced.

FIG. 2 is a method flowchart for registering an executive with a business owner on the smart calling platform, according to an example embodiment of the present disclosure.

FIGS. 3A and 3B is a method flowchart for generating a sales lead on the smart calling platform, according to an example embodiment of the present disclosure

FIG. 4 shows an exemplary system for providing a smart calling platform for management of sales leads, according to an example embodiment of the present disclosure.

FIG. 5 is a block diagram of an exemplary computer system for implementing embodiments consistent with the present disclosure is illustrated.

### DETAILED DESCRIPTION OF THE DISCLOSURE

The present disclosure will now be described more fully with reference to the accompanying drawings, in which embodiments of the present disclosure are shown. However, this disclosure should not be construed as limited to the embodiments set forth herein. Rather, these embodiments are provided so that this disclosure will be thorough and complete, and will fully convey the scope of the present disclosure to those skilled in the art. In the present disclosure, like-numbered components of various embodiments generally have similar features when those components are of a similar nature and/or serve a similar purpose.

The terms “a” and “an” herein do not denote a limitation of quantity, but rather denote the presence of at least one of the referenced item.

The term “having”, “including” and “comprising” herein refer to inclusion of at least one of the referenced items.

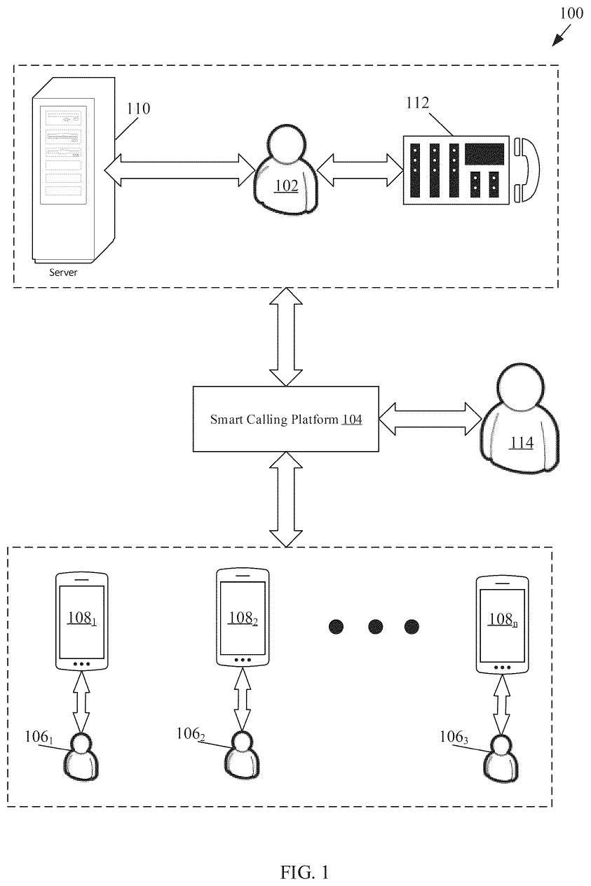

FIG. 1 illustrates an exemplary environment 100 in which various embodiments of the present disclosure can be practiced. The exemplary environment comprises a business owner 102, a smart calling platform 104, a plurality of executives 106₁ to 106ₙ (collectively referred as executives 106), a plurality of electronic devices 108₁ to 108ₙ (collectively referred as electronic devices 108), a server 110, a private branch exchange (PBX) 112, and a customer 114. The electronic device 108₁ may be associated with the executive 106₁; electronic device 1082 may be associated with the executive 106₂; and similarly electronicdevice 108ₙ may be associated with the executive 106ₙ.

In an implementation, the business owner 102 may correspond to owner of a business like insurance service provider, financial service provider, health service provider, a product company, and the like. The server 110 and the PBX 112 may be associated with the business owner 102 to facilitate installation of the smart calling application 104, facilitating the routing of the calls between the executives 106 and the customer 114, and managing the enrolments of the executives 106. The server 110 may include suitable logic, circuitry, interfaces, and/or code for at least providing storage and user account management related services for the executives 106 and the customer 114, based on one or more server technologies known in the art.

The PBX 112 may be based on a primary rate interface (PRI), Basic Rate Interface (BRI), Session Initiation Protocol (SIP) based trunking, Voice over Internet Protocol (VoIP), and the like. Specifically, with regard to SIP based trunking, the technology performs several Voice over Internet (VoIP) functions in addition to basic call setup. Such functions include, but are not limitedto, identifying user location, determining user availability, negotiating media capabilities, session setup and management (transferring and terminating calls, adding 3-way conferences, etc.), enabling instant messages, multimedia conferences, user presence information, and enhanced emergency calls. A combination of all these features in the present invention facilitates reduction in reliance on different devices and simplifies establishment of communication channel between business owners, executives, and customers.

The aforesaid technologies facilitate transmission of audio, video, and multimedia data between the executives 106, the representatives of the business owner 102, such as Level I to Level N administrators (not shown), and the customer 114. The PRI or BRI employs copper wire connections for facilitating the secure message exchange between the previously mentioned entities. Typically, a PRI makes use of 23 Beta-channels and a Delta-channel for supporting exchange of voice, data, image, and audio data. In contrast, a BRI connection makes use of two Beta-channels and a single Delta-channel for supporting exchange of voice, data, image, and audio data. A person of ordinary skill in the art will appreciate that the business owner 102 may select any of the preceding telecom technologies for allowing extensions and numbers on a single connection for the executives 106.

In an implementation, the plurality of electronic devices 108 may include suitable logic, circuitry, interfaces, and/or code for displaying one or more user interfaces of the community interaction platform on a display screen of the electronic device. Examples of implementation of the display screen of the electronic devices may include, but are not limited to, a Liquid Crystal Display (LCD) display, a Light Emitting Diode (LED) display, an Organic LED (OLED) display technology a desktop, a laptop, a personal digital assistant (PDA), and the like.

In operation, one or more executives (such as, 106₁ and 106₂) from the plurality of executives 106 may register themselves with the smart calling platform 104. The smart calling platform 104 may charge a pre-defined amount of currency to the executives for such registration. To this end, a business owner 102 may upload a list of a plurality of executives. The list includes details of the plurality of users that are enrolled with the business owner 102 with the intent of offering services.

In an embodiment, at the time of registration, the smart calling platform 104 may request information from the executives that includes, but is not limited to, one or more domains of expertise, experience in the one or more domains, one or more preferences relating to language, one or more preferences relating to compensation. The smart calling platform 104 may further perform one or more assessments to determine a level of expertise of each of the registering executives in the specified one or more domain. To this end, a knowledge database (not shown) integrated may store a repository of assessments for judging a skill level of an executive. The assessments may include questions relating to a domain, interviews, role-plays, and capabilities for real time call monitoring. The assessments may be automatically conducted by the smart calling platform 104 and the result of the assessment may be used to update the profile of the registering executive. The smart calling platform 104 generates an assessment score for the executives based on the assessment. Basis the assessment score, the smart calling platform 104 creates a training profile for each executive for periodic re-assessment of expertise in the one or more domains. For example, at the time of registrations, the smart calling platform 104 may conduct a mock tele-call with the registering executive to assess the knowledge of the executive about a domain specified by the executive and the level of linguistic proficiency. Basis the above, the smart calling platform 104 may generate an assessment score for each of the registering executives. In case the assessment score of the registering executive is above a pre-defined threshold, the smart calling platform 104 may mark the registering executive eligible for enrolments with business owners.

In scenarios, when the registering executive is found to be not meeting the assessment criteria, the smart calling platform 104 may utilize one or more training modules present in the repository, to train the executive so as to upskill the executive. To this end, the smart calling platform 104 may determine a window during which the executive is available for trainings. During such windows, the smart calling platform 104 may push one or more notifications to the executive for completing a section of the coursework required for upskilling. In another scenario, the smart calling platform 104 may allow the executive to access the training repository any time executive intends to train. Further, the smart calling platform 104 may create a profile for each of the executives and may track profile data to assess the progress of the executive. The smart calling platform 104 may conduct an assessment at the completion of the coursework to determine an assessment score. Additionally, the smart calling platform 104 may update the profile of the registered executive with assessment score and certificates earned based on coursework completion. In an embodiment, the smart training modules stored in the database may be updated with latest technological and domain knowledge, by an a super-administrator of the smart calling platform 104.

In an embodiment, the business owner 102 may receive an enrolment request from a plurality of executives 106 registered with the smart calling platform 104. The registered executives may send such a request to offer tele-calling services to the business owner 102. Based on the received request, the business owner 102 may generate a list of the executives and upload such a list on the server 110. The generation of the list may be based on application of one or more filtering criterion that may help the business owner in shortlisting the most relevant profiles of the executive who may potentially generate sales leads for the business owner 102. Once uploaded, each executive from the plurality of users 106 may be designated a unique identification number that helps the business owner 102 to track the activities of the executives 106 and correspond with them.

In an embodiment, the server 110 may directly push an application-programming interface (API) of the smart calling platform 104 on the plurality of electronic devices 108 of the plurality of executives 106, in case not installed already. In another embodiment, the plurality of executives 106 may directly request the API of the smart calling platform 104 from the server 110. Upon processing of the request, the API may be downloaded on the electronic device of the executive and installation may commence. Once installed on the electronic device of an executive, the smart calling platform 104 may require one or more authentication credentials from the executive. In an implementation, the default authentication credentials may be an identification of the executive (such as phone number or an email identification) that was provided to the business owner 102 while submitting the request for offering tele-calling service. Once the previously mentioned authentication credentials are punched in, the smart calling platform 104 may communicate the details to the server 110, which may then trigger a One Time Password (OTP), which may be shared on the identification platform provided by the executive. Once the OTP is punched in by the executive on the smart calling platform 104, a timeline that corresponds to the executive's account will be rendered on the display screen of the executive's electronic device. Further, the timeline is activated once the executive successfully logs in to the smart calling platform 104.

Upon creation of the account of the plurality of executives 106, the business owner 102 may upload and allocate one or more details of the potential customers, such as the customer 114, that are to be called by the executives for generating sales leads. In an embodiment, the one or more details may be uploaded on the form of a text file, a comma separated value (CSV) file, a relational database entry, and the like. In an embodiment, the allocation of the one or more potential customers may be based on an artificial intelligence (AI) based correlation between business data associated with each of the one or more customers and profile data of each of the plurality of executives.

In an embodiment, the uploaded details of the potential customers 114 may include, but are not limited to, customer available for calls, customers registered in Do Not Disturb (DND) registry, customers not available for being approached, customers who underwent change in contact, change in contact details of customers, customers out of coverga area, customers having specified set of preferences for services and/or products, preferred frequency of approach by tele-callers. The details may be uploaded by the business owner 102 at the server 110 that may be centrally located with respect to the plurality of executives. As a result, any updates made to the uploaded customer details may be synchronized across all the plurality of executives registered with the business owner 102 so that real-time contact information is available to executives on associated electronic devices, at all times.

Further, the details of the one or more potential customers may be redacted such that the plurality of executives are only able to see one or more portions of the uploaded one or more details pertaining to a customer. This prevents the executives from accessing the details of the customers for personal use.

In an embodiment, the smart calling platform 104 may display the details of the potential customer 114 by changing one or more components of the details of the potential customer 114 at the back-end, before the details are rendered to an executive (such as the executive 106₁). For example, if the contact details of the customer are “12345678”, the smart calling platform 104 may alter one or more digits of the contact details before they are presented to the executive 106₁. In the above scenario, the contact detail may be displayed as “0123456T”. When the executive 106₁ attempts to contact the customer above, the contact number used will be “01234567”, which will be translated to “12345678” by the smart calling platform 104 automatically at the back-end, before placing the actual call.

In an embodiment, the smart calling platform 104 may comprise a unit that may facilitate a business owner to specify a pre-defined customized identity for an executive, which is indicative of an identity of the business owner 102. As a result, whenever an executive (such as the executive 106₁) that is enrolled with a business owner (such as the business owner 102) establishes a communication channel with the potential customers, the identity that is displayed to the customer belongs to the business owner and it remains fixed for all the executives enrolled with the business owner 102. For example, if the business owner 102 selects an identity as “ABC Company”, whenever any executive that is enrolled with the business owner calls a customer, the identity that is displayed to the customer is “ABC Company”. In an embodiment, the smart calling platform mobile app may be downloaded in a mobile device of the customer 114. By this the customer will be able to understand that the calls being received are verified calls and any fraudulent calls can be averted. Further, the customer will be able to understand the source of the calling person. In an embodiment, the customer provides an input to block the source number based on one or more options displayed to the customer. The one or more options may comprise providing remarks, field type, blocking the source number and the like. In an embodiment, a plurality of business owners may upload a list of the numbers assigned to each of the executives. Thus, when the customer downloads the smart calling platform, the customer will be able to identify the correct source of the number from which the call is received.

In an embodiment, each of the customer and the executives, and the business owners may rate the smart calling platform to provide a feedback. Similarly, the smart calling platform may generate a rating for each of the customer, executive and the business owner. In an embodiment, the executive and the business owner may also provide a rating the consumer. For example, the smart calling platform may utilize machine learning techniques and analyse the speed tone, speed words, and the like to provide a rating to each of the customer, executive and the business owner. For example, if the customer is using abusive words while corresponding then the rating of the customer is lowered. Similarly, if the executive does not respond to queries of the customer then the rating of the executive is reduced.

In an embodiment, the Level I (admin) and/or Level II (super admin) administrator may designate a calling target to each of the executive portion enrolled with the smart calling platform 104. To this end, the administrator may make use of allocation algorithms present at the server 110 for setting the target. The target may be based on the amount of compensation sought/offered to an executive by the business owner 102. In an embodiment, the target may have a linearly proportional relationship with the compensation, which in other words means, highly compensated executives will be allocated higher targets. In another embodiment, the target additionally may be correlated with the expertise and experience level of an executive. Highly trained or experienced executives may be allocated higher targets. In yet another embodiment, the target may be proposed by the executive themselves based on the amount of time they intend to invest in the activity. The smart calling platform 104 may ensure that a steady pipeline of target is maintained for each of the enrolled executives. The pipeline may be populated in real-time by the admin and the super admins and the correlation of the pipeline volume may be maintained with at least the expertise, experience level, and compensation of the enrolled executives.

Additionally, the server may divide the list of potential customer in multiple sets depending on the number of executive designated for making calls and the number of calls to be made. Further, in order to prevent spanning of a set of potential customers (such as customer 114), the server 110 may ensure that no single customer is features in more than one such sets.

Once the target is defined, an executive, such as the executive 106₁ may intend to commence the tele-calling from the associated electronic device 108₁. To this end, the executive 106₁ may launch the smart calling platform 104 on the electronic device 108₁ and open an interface that lists the details of a potential customer (such as the customer 114). Also, the timeline logging the activities of the executive towards achieving the target may be automatically activated upon launching and successful authentication of the executive, by the smart calling platform 104.

It is to be noted here that while the timeline of the executive 106₁ is active, the smart calling platform 104 may restrict the access of the executive for using the dialler or messaging applications on the electronic device 108₁. This is intended to ensure that the details of the customers shared by the business owner 102 with the enrolled executives 106 is not misused for purposes other than serving the interest of the business owner 102. In scenarios, when the executive 106₁ receives a personal communication while the timeline of the executive 106₁ is active, the smart calling platform 104 may change the state of the timeline to dormant state automatically or based on an explicit input from the executive 106₁ and only then allow the executive 106₁ to toggle to a UI for accessing the personal communication. The smart calling platform 104 further ensures that no other API installed on the electronic device 108₁ of the executive 106₁ is allowed to pull any data or information from the smart calling platform 104.

Upon selection of the contact of the customer 114, the executive 106₁ may initiate correspondence with the customer 114 via a communication channel that facilities exchange of telephone call, email, multimedia exchange, and the like. To this end, the smart calling platform 104 may present adequate user interface (UI) objects to the executive 106₁ for selecting a preferred mode of correspondence. Further, upon receiving a selection input, the smart calling platform 104 may initiate recording of the correspondence between the executive 106₁ and the customer 114.

In an embodiment, the correspondence may be based on a first method in which the executive 106₁ directly uses the contact details of the customer 114 for initiating the correspondence.

In another embodiment, the correspondence may be based on a second method in which the executive 106₁ directly uses the contact details of the customer 114 for initiating the correspondence, but the request is routed by the smart calling platform 104 to the PBX 112. The PBX 112 identifies the executive 106₁ using the PRI/BRI identification and upon successful authentication, establishes the communication channel between the executive 106₁ and the customer 114, while acting as an intermediary.

In yet another embodiment, the correspondence may be based on a third method in which the executive 106₁ directly uses codes corresponding to a contact of the customer. The code is transmitted by the smart calling platform 104 to the server 110 where it is translated into actual contact details of the customer 114 based on a pre-defined mapping between the codes and the contact details. Upon successful translation, the server 110 establishes the communication channel between the executive 106₁ and the customer 114, while acting as an intermediary.

In an embodiment, to allay the fear of the customers 114 regarding the authenticity of a tele-calling executive, the smart calling platform 104 may play (and/or render) a customized message upon successful establishment of the communication channel. The message may be indicative of an identity of the business owner and/or the tele-calling executive and may contain details that include, but are not limited to, a registration license information, a government identification, an photographic identity proof, and/or a disclaimer. This enables the customer 114 to proceed with the sharing of information without any fear of it being used by a rogue entity. Additionally, upon the commencement of the correspondence, the smart calling platform 104 may explicitly inform the customers that the correspondence will be recorded and if required, can be shared with the customer via secure multimedia exchange platforms known in the art.

In an embodiment, while the communication channel is live, the smart calling platform 104 may redact the identities of the executive 106₁ and the customer 114 in order to enable privacy. For example, when the communication channel is video connection, the names of the executive 106₁ and the customer 114 may be garbled by use of alphanumeric codes, or certain portions thereof may be redacted by the smart calling platform 104. Further, once an executive is authenticated and is logged into the smart calling platform 104, all activities of the executive may be logged on the timeline of the executive, presentedon a UI associated with the smart calling platform 104.

In an embodiment, when the executive 106₁ attempts to contact the customer 114 and the customer 114 is not able to pick up, upon an attempt by the customer 114 to call the executive 106₁, the smart calling platform 104 may block the call in case the application is inactive on the electronic device of the executive 106₁. In another embodiment, when the customer 114 calls back, the smart calling platform 104 may initiate a session of the executive 106₁ on the application and as is the case above, may also redact the customer 114 information that is displayed to the executive 106₁ while the communication channel is established between the two. In yet another embodiment, if the executive 106₁ is not online (due internet unavailability) when customer 114 attempts a callback, the smart calling platform 104 may generate one or more notifications for the executive 106₁ to alert it about the possible callback(s) from approached customers (such as the customer 114).

In an embodiment, upon completion of the correspondence, the smart calling platform 104 may stop the recording and transmit the recording to the server 110 for analysis. In an embodiment, the recording may be transmitted to the customer based on the request from the customer. The server 110 may perform a machine learning analysis on the received correspondence and may generate insights on the maturity (using maturity score) of the sales leads generated based on the correspondence between the executive 106₁ and the customer 114. To this end, the machine learning algorithms present at the server 110 may analyse the information shared by the executive 106₁ and corresponding response of the customer 114. A person of ordinary skill in the art will appreciate that the machine learning algorithm implemented for the purpose of analysing the correspondence may include, but are not limited to, Support Vector Machines, Bayesian Networks. Maximum Entropy, Conditional Random Field, Neural Networks/Deep Learning (NN/DL), and/or other Natural Language Processing (NLP) techniques known in the art.

For example, if the executive 106₁ shares details of a real-estate project with the customer 114 and in response, if the customer 114 inquires about the specifics of the project, the machine learning algorithm may infer that the customer 114 is interested. Upon further inquiries from the customer 114, the machine learning algorithms may infer that the customer 114 actually intends to buy a property. Accordingly, the machine learning algorithm may index the maturity of the sales lead on a pre-defined scale and may update the maturity of the sales lead against the profile of the executive 106₁ and the same may be reflected in real-time on the smart calling platform 104 timeline of the executive 106₁.

In another example, when the customer 114 responds to an initiated correspondence with a phrase “not interested”, or abruptly hangs up the call, the machine learning algorithm may infer that the sales lead will not progress further and may generate automatic prompt for the executive 106₁ to not call the customer 114 further for the same business proposition. Further, in an embodiment, the server 110 may also initiate a timer, until the expiry of which, the customer 114 is not allocated to any of the plurality of executive 106 for making a sales pitch for the business proposition which was rejected by the customer 114. In another embodiment, the timer may also be initiated in scenarios where a sales lead has been successfully generated and has matured to pre-defined maturity levels. This ensures that the customers are not repeatedly contacted for same business propositions thereby reducing network overheads and redundancies in the efforts.

In another embodiment, the smart calling platform 104 may generate the summary of the correspondence based on the machine learning algorithms. The summary may include generation of a knowledge graph and the same may be stored at the server 110 for future reference. In addition to the generated summary, the smart calling platform 104 may further prompt the storage of the metadata of the correspondence along with the result of the analysis, at the server 110, wherein the storage is performed in a manner that the insights are tagged to the executive 106₁ and the customer 114. Further, the executive 106₁ may be presented with one or more UI objects to retrieve the stored details from the sever 10 to the timeline rendered on the electronic device 108₁.

In a scenario, the correspondence between the executive 106₁ and the customer 114 may involve exchange of PII, financial information, medical information, and other sensitive information. In such a scenario, if such a recording is made available to other users (business owners or peer executives) of the platform for vetting, the sensitive information may be leveraged by such users for their personal use without adequately compensating the executive 106₁. To prevent such leakages, in an embodiment, the smart calling platform 104 in conjunction with the server 110 may perform analysis of the recording to determine portions containing sensitive information which can be misused or commercialized without the consent of the executive 106₁. Based on the analysis, the smart calling platform 104 may perform steps that include, but are not limited to, redacting, garbling, muting, editing, such portions from the recording. However, upon successful transfer of the recording by virtue of a bidding or any other transaction, such portions maybe replaced with the original content.

In an embodiment, the metadata may include, but is not limited to, details of the executive, rating of the executive, rating of a business owner, historical record of number of calls made by an executive, number and details of the customer contacted by the executive, number of pick-ups by the customer, number of favourable responses by the customer, maturity indices of each of the sales leads, remarks provided by the executive or the business owner on a sales lead.

In an embodiment, the smart calling platform 104 facilitates generation of appropriate notifications in the event the customer initiates a call to the executive 106₁ or intends to responds to a correspondence initiated by the executive 106₁ in any of the preceding instances. In a scenario, when customer 114 calls the executive 106₁, and the timeline of the executive 106₁ is inactive and the smart calling platform 104 UI is not launched on the electronic device 108₁ of the executive 106₁, one or more notifications may be generated to alert the executive 106₁. In another embodiment, when the executive 106₁ launches the UI of the smart calling platform 104, the details of the customer who had attempted to contact the executive 106₁ may be highlighted in a format which is different from the format of the other information rendered on the UI. For example, the smart calling platform 104 may use various colored UI objects, re-arranging the placement of the lart on the UI, and/or animation to highlight any missed correspondence. Furthermore, the smart calling platform 104 may ensure that the details of the customer 104 are redacted before being rendered on the U.

In another embodiment, the generated insights may be stored locally at the electronic device 108₁ of the executive 106₁, Such a storage scenario is especially applicable when the executive 106₁ is provided an option to bid for the sales lead that has been generated. In such a bidding eco-system, one or more UI objects are presented on the electronic device 108₁ of the executive 106₁ for facilitating the bidding process. Once the executive 106₁ is satisfied with the sales lead, the executive 106₁ may enlist the sales lead on the bidding page of the smart calling platform 104, whereby a plurality of business owners (such as the business owner 102) may be able to access the generated sales lead on the associated electronic devices. The smart calling platform 104 may further enable such plurality of business owners to interact with the generated sales lead by enabling them to watch, listen, analyse, and consume the sales lead. To this end, the business owners may be presented with one or more criterion for filtering the sales leads generated and listed on smart calling platform 104. Conversely, the smart calling platform 104 may present the previously mentioned criterion for filtering to the plurality of executives 106 as well so as to enable them to take control of who is able to see the sales leads generated by them, and accordingly take controlling stake of the bidding process.

In an embodiment, the bidding process may involve transaction corresponding to transfer of a sales lead between one or more executives and one or more business. In another embodiment, the bidding process may involve transaction corresponding to transfer of a sales lead amongst one or more executives or amongst the one or more business.

Once one or more business owners from the plurality of business owners are satisfied with the maturity of the sales lead, or prospects thereof, they may bid for the sales lead using a currency specified by the smart calling platform 104. The bids may be presented to the executive 106₁ in an order based on one or more pre-defined preference of the executive 106₁. Additionally, the smart calling platform 104 may further present trust ratings associated with a bidder to the executive 106₁. Based on the aforesaid information, the smart calling platform 104 may receive a bid acceptance input from the executive 106₁ corresponding to a preferred bid, and accordingly, the smart calling platform 104 may execute conclude the bid and update the timeline of the executive 106₁.

Conversely, the smart calling platform 104 may facilitate the business owners (such as the business owner 102) to provide quality ratings to the executives based on the sales leads generated by the executives (such as the executive 106₁). For example, when a business owner 102 buys a sales leads from the executive 106₁, depending on the maturity of the sales leads and successful revenue realization by virtue of the sales lead, the business owner 102 may update the quality rating of the executive 106₁, which may be displayed by the smart calling platform 104 on the profile of the executive 106₁. Such a quality rating may be indicative of the quality of sales leads generated by the executive 106₁ and may provide insights to the business owners bidding for the sales leads put up for auction by the executive 106₁.

In an embodiment, the details on successful bid closures associated with each of the one or more executives may be updated at the server 110 and information may be made available to the business owners and plurality of executives 106 alike for making informed decisions while transacting. In another embodiment, the bidding data may be analysed based on the machine learning algorithms and a plurality of dashboards (depicting historical bidding data and trends) may be generated and rendered on the UIs of the business owners and the plurality of executives 106.

In an embodiment, the plurality executives 106 that may not have been enrolled with any business owner, may independently call one or more filtered customers 114 using the smart calling platform 104. During such calls, the executives may extract one or more requirements from the customer 114. Based on the extracted requirements, the server 110 may automatically update the remarks of the correspondence in the metadata of the sales lead. Once the corpus of the remarks generated for such calls exceeds a pre-defined classification level, the smart calling platform 104 may categorize the requirements of the customer under various categories and may present the categorized information to the executives and/or the business owners. In a scenario, when the categorized information is presented only to an executive, the executive may leverage the categorization information and apply filtering criterion on the business owners to whom the sales leads containing the requirements can be bid to. In another scenario, when the categorization information is made available to the business owners, the business owners may shortlist such independently generated sales leads and may approach the executives with a bid.

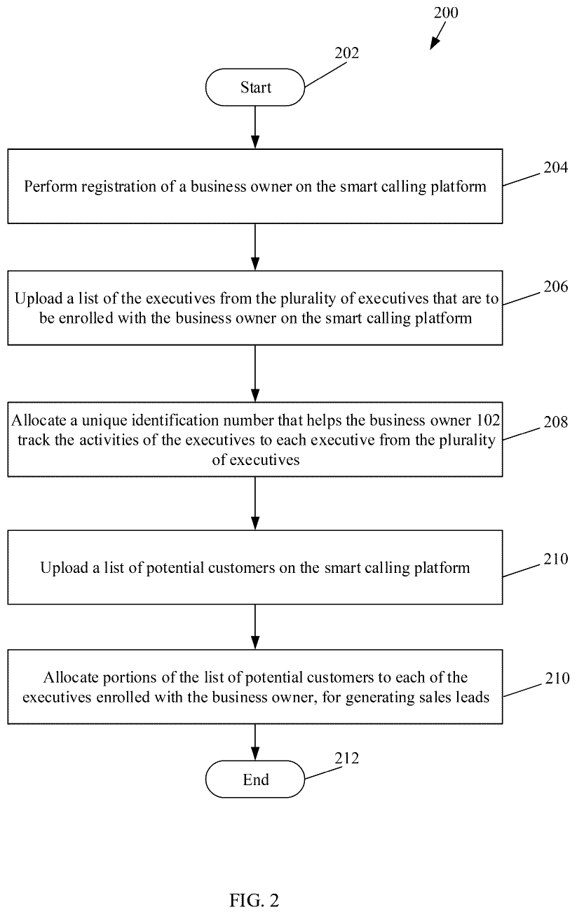

FIG. 2 is a method flowchart for registering an executive with a business owner on the smart calling platform, according to an example embodiment of the present disclosure. With reference to FIG. 2, there is shown a flow chart 200. The flow chart 200 is described in conjunction with FIG. 1. The process starts at step 202 and proceeds to step 204.

At step 204, a registration of a business owner 102 may be performed on the smart calling platform 104. At step 206, a list of the executives from the plurality of executives 106 that are to be enrolled with the business owner 102, may be uploaded on the smart calling platform 104. In an embodiment, an enrolment request from a plurality of executives 106 registered with the smart calling platform 104 may be received by the business owner 102. The registered executives may send such a request to offer tele-calling services to the business owner 102.

At step 208, a unique identification number that helps the business owner 102 to track the activities of the executives 106 may be allocated to each executive from the plurality of executives 106. The generation of the identification may be performed by the PBX 112 in conjunction with the server 110. At step 210, a list of potential customers may be uploaded by the business owner on the smart calling platform 104. At step 212, portions of the list of potential customers may be allocated to each of the executives enrolled with the business owner 102 for generating sales leads. The control passes to end step 214.

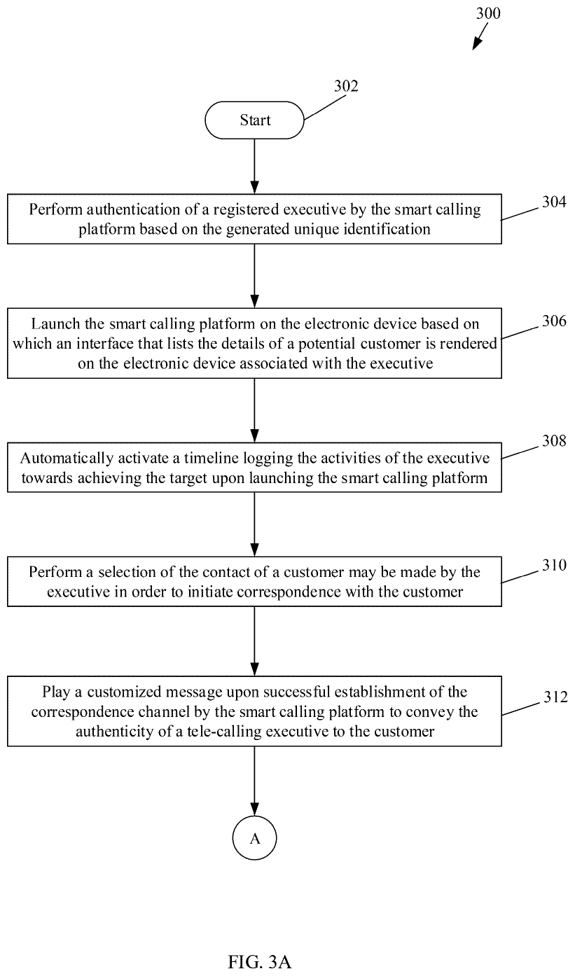

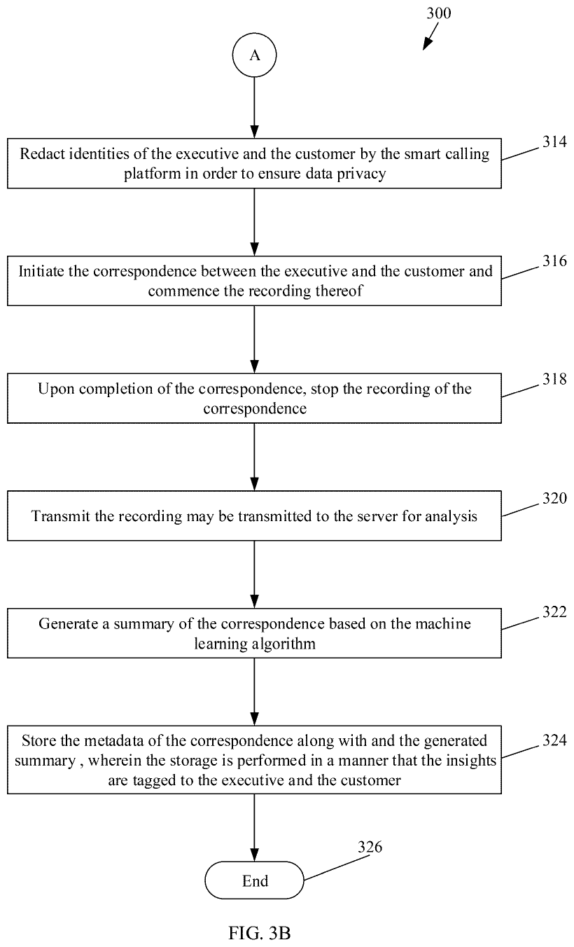

FIGS. 3A and 3B is a method flowchart for generating a sales lead on the smart calling platform, according to an example embodiment of the present disclosure. With reference to FIGS. 3A and 3B, there is shown a flow chart 300. The flow chart 300 is described in conjunction with FIGS. 1 and 2. The process starts at step 302 and proceeds to step 304.

At step 304, the authentication of a registered executive may be performed by the smart calling platform 104 based on the generated unique identification. At step 306, the smart calling platform 104 may be launched on the electronic device 108₁ and an interface that lists the details of a potential customer (such as the customer 114) may be rendered on the electronic device associated with the executive.

At step 308, a timeline logging the activities of the executive towards achieving the target may be automatically activated upon launching the smart calling platform 104. In certain scenarios, when the executives correspond to a recovery agent who is operating on behalf of a business owner that may be a financial institution lending loans, there may be a possibility that the customer being called is threatened or the guidelines for calling the customer are not followed appropriately. For example, the recovery agent may unduly threaten the customer being called for recovering the due amount. There is also a possibility of the recovery agent may act in cahoots with his fellow agents and may try to siphon off the amounts received as recovery money from the customers. Further, the to complete the recovery target, the recovery agent may resort to calling the customers at frequent time intervals and at time when the businesses are not operational as per the specified guidelines of the authorities, such as Telecom Regulatory Authority of India (TRAI).

To prevent harassment of the customer caused by recovery agent behaviours cited above, the smart calling platform 104, in an embodiment, may restrict the access of the timeline by the recovery agents to certain fixed hours during the day as specified by the governing authorities, such as TRAI. For example, if the TRAI has specified the operational hours for tele-calling executives of the financial institutions as 9 AM to 5 PM, the smart calling platform 104 may allow the recovery agent to access the timeline on the platform 104 only during this time interval.

In another embodiment, the smart calling platform 104 may record the correspondence between the recovery agent and the customers and the recording may be shared with the financial institution. This enables the financial institutions to monitor the conversations so that no guideline for tele-calling is violated by the recovery agent. Further, this also enables the financial institution to monitor the amount cited by the recovery agent over the correspondence and correlate it with the actual amount due, thereby preventing frauds and customer harassment. In yet another embodiment, the smart calling platform 104 may enable the financial institutions to share only redacted customer information so that no recovery agent is able to leverage the customer PII in any way and make unjust utilization thereof, which is not in alignment with the agenda of the financial institution.

At step 310, a selection of the contact of a customer (such as the customer 114) may be made by the executive in order to initiate correspondence with the customer 114. In an embodiment, the correspondence may be based on a first method in which the executive 106₁ directly uses the contact details of the customer 114 for initiating the correspondence. In another embodiment, the correspondence may be based on a second method in which the executive 106₁ directly uses the contact details of the customer 114 for initiating the correspondence, but the request is routed by the smart calling platform 104 to the PBX 112. The PBX 112 identifies the executive 106₁ using the PRI/BRI identification and upon successful authentication, establishes the communication channel between the executive 106₁ and the customer 114, while acting as an intermediary. In yet another embodiment, the correspondence may be based on a third method in which the executive 106₁ directly uses codes corresponding to a contact of the customer. The code is transmitted by the smart calling platform 104 to the server 110 where it is translated into actual contact details of the customer 114 based on a pre-defined mapping between the codes and the contact details. Upon successful translation, the server 110 establishes the communication channel between the executive 106₁ and the customer 114, while acting as an intermediary.

At step 312, a customized message upon successful establishment of the communication channel may be played by the smart calling platform 104 to convey the authenticity of a tele-calling executive to the customer. At step 314, identities of the executive 106₁ and the customer 114 may be redacted by the smart calling platform 104 in order to ensure data privacy. In an embodiment, the smart calling platform 104 may comprise a DRD unit that may facilitate a business owner to fix a calling executive identity that is indicative of the business owner. As a result, whenever an executive (such as the executive 106₁) that is enrolled with a business owner (such as the business owner 102) establishes a communication channel with the potential customers, the identity that is displayed to the customer belongs to the business owner and it remains fixed for all the executives enrolled with the business owner 102. For example, if the business owner 102 selects an identity as “ABC Company”, whenever any executive that is enrolled with the business owner calls a customer, the identity that is displayed to the customer is “ABC Company”.

At step 316, the correspondence between the executive and the customer may be initiated and recording thereof may be commenced. At step 318, upon completion of the correspondence, the recording of the correspondence may be stopped. At step 320, the recording may be transmitted to the server 110 for analysis. The server 110 may perform a machine learning analysis on the received correspondence and may generate insights on the maturity of the sales leads generated based on the correspondence between the executive 106₁ and the customer 114.

At step 322, a summary of the correspondence may be generated based on the machine learning algorithms. At step 324, the metadata of the correspondence along with and the generated summary may be stored, wherein the storage is performed in a manner that the insights are tagged to the executive 106₁ and the customer 114. The control passes to end step 326.

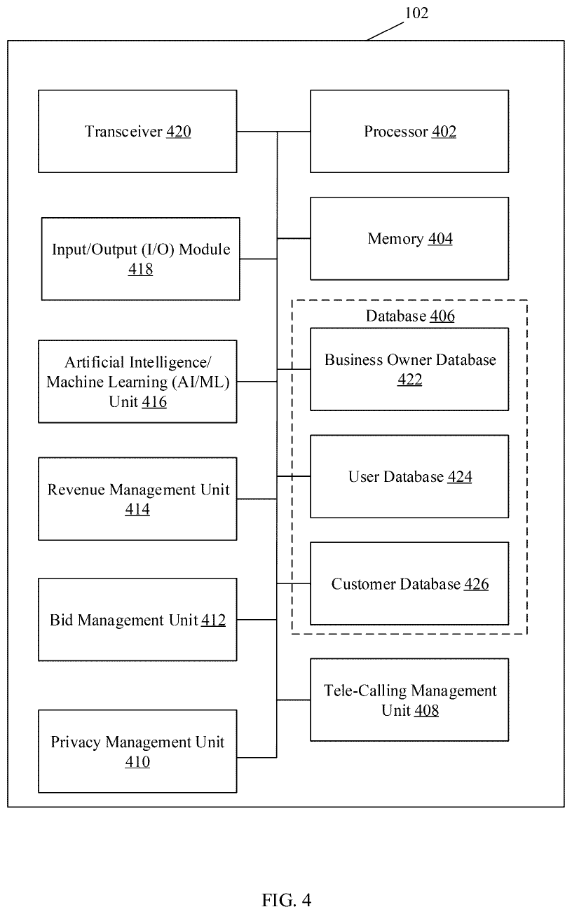

FIG. 4 shows an exemplary system for providing a smart calling platform for management of sales leads, in accordance with some embodiments of the present disclosure. FIG. 4 is explained in conjunction with elements from FIGS. 1 to 3B. With reference to FIG. 4, there is shown the smart calling platform 102 that may include one or more processors, such as a processor 402, a memory 404, database 406, tele-calling management unit 408, privacy management unit 410, bid management unit 412, revenue management unit 414, artificial intelligence/machine learning (AI/ML) unit 416, input/output unit (I/O) unit 418, and transceiver 420.

The processor 402 may include suitable logic, circuitry, interfaces, and/or code that may be configured to execute a set of instructions stored in the memory 404. The processor 402 may be configured to register the plurality of business owners (such as the business owner 102), the plurality of executives 106, and/or the potential customers 114 with the smart calling platform 104. The processor 402 may be configured to track the correspondences between the executives and the potential customers while also tracking the progress of the sales leads. The processor 402 may be further configured to manage the transactions relating to the bidding performed between the stakeholders (used to refer to the business owner, executives 106, and the customer 114, collectively) registered with the smart calling platform 104. Examples of the processor 402 may be an X86-based processor, a Reduced Instruction Set Computing (RISC) processor, an Application-Specific Integrated Circuit (ASIC) processor, a Complex Instruction Set Computing (CISC) processor, and/or other processors.

The memory 404 may include suitable logic, circuitry, and/or interfaces that may be configured to store a machine code and/or a computer program with at least one code section executable by the processor 402. In an embodiment, the memory 404 may be configured to store the details related to the plurality of business owners 102, the plurality of executives 106, the potential customer 114, the correspondences between the stakeholders, the historical data pertaining to the correspondences, the stakeholders, and the bidding performed on the smart calling platform 104. The memory 404 may be further configured to store computed scores, such as the proficiency score, and/or the expertise index. Examples of implementation of the memory 404 may include, but are not limited to, Random Access Memory (RAM), Read Only Memory (ROM), Hard Disk Drive (HDD), and/or a Secure Digital (SD) card.

The database 406 may include suitable logic, circuitry, interfaces, and/or code that may be configured to store the personal information of the various stakeholders. Various sections of the database 406 may be specialized for storing the data pertaining to a stakeholder. For example, the business owner database 422 may store data pertaining to the business owner 102. The user database 424 may store data pertaining to the plurality of executives 106. The customer database 426 may store data pertaining to the potential customers 114. The aforementioned databases may be configured to store the personal information of the stakeholders at the time of registration of the stakeholders with the smart calling platform 104. In an implementation, the database 406 may be an entity separate from the memory 404 (as shown). In another implementation, the database 406 may be integrated with the memory 404. The database 406 may be further configured to facilitate storage of ranking data relating to executives operating under part-time engagement, full-time engagement, commission based engagement, and the like.

The tele-calling management unit 408 may include suitable logic, circuitry, interfaces, and/or code that may be configured to update the list having contact details of the business owners 102 and the plurality of executives 106. The tele-calling management unit 408 may be configured to verify the details of the calls received by the smart calling platform 104 and/or the calls received by the plurality of executives 106. The tele-calling management unit 408 may be configured to allow the business owners 102 and the plurality of executives to search and merge the contact details of the potential customers. A person of ordinary skill in the art will appreciate the such an operation may be regulated based on the access rights provided to each of the aforesaid stakeholders, by the processor 402.

The tele-calling management unit 408 may be further configured to automatically generate pre-defined messages upon disconnection of the call any of the stakeholders enrolled or registered with the smart calling platform 104. The tele-calling management unit 408 may be configured to update the details and/or facilitate blocking of a stakeholder making a call to another via the smart calling platform 104. The tele-calling management unit 408 may be configured to verify the details of the calls received by the smart calling platform 104 and/or the calls received by the plurality of executives 106. The tele-calling management unit 408 may be configured to verify the details of a stakeholders while an incoming or an outgoing call is attempted by the stakeholder. In case the stakeholder is blocked the processor 402 in conjunction with the tele-calling unit 408 may not allow the calling channel to be established. The tele-calling management unit 408 may be configured to verify the details of the calls received by the smart calling platform 104 and/or the calls received by the plurality of executives 106. The tele-calling management unit 408 in conjunction with the I/O unit 418 may be further configured to update the timelines of the plurality of executives 106 generating the sales leads based on the calling history.

The tele-calling management unit 408 may be configured to verify the details of the calls received by the smart calling platform 104 and/or the calls received by the plurality of executives 106. The tele-calling management unit 408 may be configured to facilitate shortlisting of a stakeholder by another based on criterion that include, but are not limited to, as age, gender, rating, income, interests, industry, domain. The tele-calling management unit 408 may be further configured to facilitate the recording of the calls established between the stakeholders registered on the smart calling platform 104. The tele-calling management unit 408 may be further configured to facilitate updating of the recording of the calls established between the stakeholders registered on the smart calling platform 104 with remarks provided by the various stakeholders involved in a call. The tele-calling management unit 408 may be further configured to facilitate transferring of calls between the administrators placed at various levels of hierarchy in the system.

The privacy management unit 410 may include suitable logic, circuitry, interfaces, and/or code that may be configured to redact the details of the stakeholders registered with the smart calling platform 104. The privacy management unit 410 may be configured to redact the details of the stakeholders during an outgoing call from the smart calling platform 104. The privacy management unit 410 may be configured to redact the details of the stakeholders during an outgoing call from the smart calling platform 104. The privacy management unit 410 may be configured to translate the redacted details of the stakeholders during a call into actual details. The privacy management unit 410 may be configured to perform a hidden function of mapping redacted details (which may be a code) of a stakeholder to actual detail. The privacy management unit 410 may be configured to perform a hidden function of mapping redacted details (which may be a code) of a stakeholder to actual detail. The privacy management unit 410 may be configured to verify incoming call and dynamically redact the details of the call.

The bid management unit 412 may include suitable logic, circuitry, interfaces, and/or code that may be configured to facilitate the bidding of the generated sales lead (explained in detail in FIG. 1). The bid management unit 412 may be configured to facilitate transfer of the generated sales lead among the stakeholders depending on the result of the bidding.

The revenue management unit 414 may include suitable logic, circuitry, interfaces, and/or code that may be configured to manage the settlement of the commission or remuneration of the plurality of executives 106 enrolled with a business owner, based on the amount of effort put in generating the sales leads. The model for settling the commissions may be based on part-time engagement, full-time engagement, commission based engagement, and the like. The AML unit 416 may include suitable logic, circuitry, interfaces, and/or code that may be configured to perform analyses on the correspondences made between the stakeholders (explained in detail in FIG. 1).

The I/O unit 418 may include suitable logic, circuitry, interfaces, and/or code that may be configured to render the details of the stakeholders on the electronic devices of the respective stakeholders. The I/O module 418 may be configured to render other details of the stakeholders (discussed in detail in FIG. 1) on the UI of the smart calling platform 104. The I/O module 418 may include various input and output devices that may be facilitate communication between the stakeholders. In an implementation, the one or more electronic devices that, in conjunction with the I/O module 418, may be configured to display one or more interfaces for exchange of services between the PSP and the user, via a respective display screens or audio/visual device. Examples of the display screens may include, but are not limited to, Liquid Crystal Display (LCD) display, Light Emitting Diode (LED) display, Organic LED (OLED) display technology, and/or the like.

In an implementation, the I/O unit 418 may be further equipped with a photographic optical system, such as a photographic lens and/or a zoom lens, as well as one or more image sensors, such as a charge-coupled device (CCD) or a complementary metal-oxide-semiconductor (CMOS), a digital camera, a camera embedded in a personal digital assistant (PDA), a video camera, and/or a motion camera. A person of ordinary skill in the art will appreciate that the VO unit 418 may further include one or more audio based output devices for enabling communication with a community club member or an administrative user. This enables the user to provide photographic inputs to the smart calling platform 104 that may include, but are not limited to, documents relating to product, documents relating to an identity of the user, pictures of a desired product which is to be ordered, pictures of an already order product to convey its working status, and the like.

The transceiver 420 may include suitable logic, circuitry, interfaces, and/or code that may be configured to facilitate communication among the plurality of business owners, the plurality of executives 106, and the customers 114. The transceiver 420 may be implemented based on known technologies to support wired or wireless communication. The transceiver 420 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 420 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), Long Term Evolution (LTE), time division multiple access (TDMA), Bluetooth, Wireless Fidelity (Wi-Fi)(such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor may be configured to receive a list of a plurality of executives from a business owner 102 registered with the smart calling platform 104 in the business owner database 422. The list includes details of the plurality of users that are enrolled with the business owner with the intent of offering services. The details may be stored in the user database 424. In an embodiment, the processor 202 may be configured to register each of the plurality of executives based on details received from the executives at the time of registration. The details include, but are not limited to, one or more domains of expertise, experience in the one or more domains, one or more preferences relating to language, one or more preferences relating to compensation.

Upon registration, the processor 202 may be configured to determine a level of expertise of the registering executives in the one or more domains based on assessments. The assessments includes questions relating to the one or more domains, interviews, role-plays, and capabilities for real time call monitoring. The assessment score generated based on the assessment may be stored in the user database 424. The processor 202 may be further configured to create a training profile for each executive for periodic re-assessment of expertise in the one or more domains, based on the generated assessment score.

A person of ordinary skill in the art will appreciate that the list of a plurality of executives provided by the business owner 102 may be generated based on application of one or more filtering criteria by the business owner on at least the required domain expertise and assessment score.

In an embodiment, the processor 202 may be configured to allocate a unique identification to each of the plurality of executives for providing authenticated access of the smart calling platform 104 to each of the plurality of executives. The processor 202 in conjunction with the database 406 may be configured to authenticate the plurality of executives based on the allocated unique identification. Upon successful authentication, the processor 202 in conjunction with the customer database 426 may be configured to allocate one or more potential customers to each of the plurality of executives. The one or more potential customers may be allocated from a list of potential customers uploaded on the smart calling platform by the business owner 102.

In an embodiment, the allocation of the one or more potential customers may be performed by the processor 202 in conjunction with the AI/ML unit 416 whereby the allocation may be based on an artificial intelligence (AI) based correlation between business data associated with each of the one or more customers and profile data of each of the plurality of executives.

In an embodiment, each of the executives from the plurality of executives may be able to access business information of the business owner and the one or more potential customers, for generating the sales leads. The information may be rendered by the processor 202 in conjunction with the I/O module 418 on an electronic device associated with an authenticated executive. In an embodiment, the processor 202 in conjunction with the privacy management unit 410, may be configured to redact portions of the business information of the business owner and the one or more potential customers for privacy and prevention of misuse of information by the executives.

In an embodiment, once an executive is authenticated and is logged into the smart calling platform, the processor 202 in conjunction with the privacy management unit 410 may be configured to monitor all activities of the executive on a timeline presented on a UI presented by the I/O module 418 on the electronic device of the executive. Further, once an executive is authenticated and is logged into the smart calling platform 104, the processor 202 in conjunction with the privacy management unit 410 may be configured to restrict access of the executive to one or more default functionalities of the electronic device associated with the executive.

In an embodiment, the processor 202 in conjunction with the tele-calling management unit 408, may be configured to configure the caller identity of an executive in a manner that identity belonging to the business owner may be presented when the executive establishes a communication channel with the one or more potential customers. The communication channel enables exchange information between the executive and the potential customer, via the transceiver 420. The information includes, but is not limited to, telephone call, email, multimedia exchange between the customer and the executive.

In an embodiment, the processor 202 may be configured to generate the communication channel based on a first method in which an executive from the plurality of executives uses the contact details of the one or more potential customers for initiating the correspondence for generation of sales leads. In another embodiment, the processor 202 may be configured to generate the communication channel a second method in which an executive from the plurality of executives uses the contact details of the one or more potential customers for initiating the correspondence fir generation of sales leads, but the request is routed by the smart calling platform to a private branch exchange. In yet another embodiment, the processor 202 may be configured to generate the communication channel based on a third method in which an executive from the plurality of executives uses codes corresponding to a contact of the one or more potential customers. The code may be transmitted by the smart calling platform to a server (such as the server 110) where it may be translated into actual contact details of the one or more potential customers based on a pre-defined mapping between the codes and the contact details. Further, upon successful translation, the server 110 may establish the communication channel between an executive a potential customer, while acting as an intermediary.

In an embodiment, the processor 202 in conjunction with the privacy management unit 410 may be configured to monitor one or more activities of each of the plurality of executives. The activities include generation of sales leads by the plurality of executives. The processor 202 in conjunction with the transceiver 420 and the AI/ML unit 416, may be further configured to transmit the generated sales leads to the server 110 for analysis and insight generation by use of AI. The insight generation may include determining summary of the generated sales leads. The summary may include, but is not limited to, a probability of conversion of a sales lead, status of resolution of a grievance, and the like.

In an embodiment, the processor 202 in conjunction with the revenue management unit 414 and the bid management unit 412 may be configured to managing business transaction associated with the generated sales leads based on the monitoring. The management comprises storing the generated sales leads and tracking maturity thereof using a maturity score. In an embodiment, the processor 202 in conjunction with the bid management unit 412 may be configured to enable reassignment of the generated sales leads between a plurality of business owners and/or the plurality of executives. The reassignment may be based on a bid placed by business owners from the plurality of business owners and/or executives from the plurality of executives. The bid may be placed based on analysis of the determined summary of the sales leads.

In an embodiment, the processor 202 may be configured to facilitating generation of customized notifications for the business owners that are triggered when the plurality of executives establish a communication channel with the one or more potential customers, while generating sales leads for the business owner.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

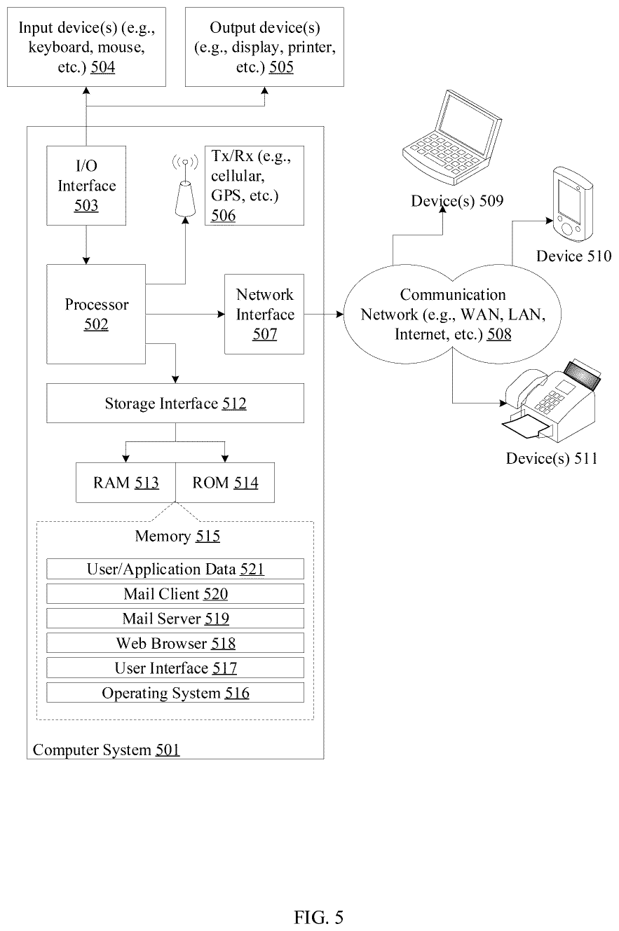

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing network environment 100 for transmitting data over a communication network 108. Computer system 501 may include a central processing unit (“CPU” or “processor”) 502. Processor 502 may include at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors. IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas. S-Video, VGA. IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor. GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver 506 may facilitate various types of wireless transmission or reception. For example, the transceiver 506 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect. Ethernet (e.g., twisted pair 10/100/1000 Base T), transmission control protocol/internet protocol (TCP/IP), token ring. IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513. ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 515 may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., past ticket repository, keywords, Ngrams, clusters or categories, relationship mapping, user queries, resolutions, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide protection to the customers in terms of ensuring the privacy of sensitive data that is attributed to them. By redacting the smart calling platform proposed above ensures that none of the prevailing laws on privacy are violated in tele-calling setup. This also ensures that the tele-calling executives are not able to use the PII of customers for their personal gains thereby protecting the interests of business owners as well. The proposed method and system allow for tracking of maturity of sales leads. In other words, in case a sales lead starts to mature and the customer intends to contact the tele-calling executive for additional information or confirmation, the proposed system provides an efficient solution by enabling a communication channel between the customer and the executive whereby both can engage in exchange of multimedia content.

The proposes method and system by enabling tracking of the progress of the sales leads generated by the tele-calling executives, allow for settlement of compensations that are inline with the status quo of a sales lead. This also dissuades the tele-callers to feed incorrect information to the business owners, who end up compensating the tele-calling executives, in spite of not realising any business outcome. From the point of view of the tele-calling executives, on occasions where the tele-calling executives put in substantial amount of time and effort but the trail goes cold at the penultimate steps where the sales leads could have been translated into actual business, the proposed invention allows for just remuneration to be provided to the executives in accordance with the effort put in. This again is enabled by tracking of maturity of sales leads. Additionally, the proposed invention also supports reassignment of sales leads between the business owners and/or the executives, thereby creating a commercial eco-system where everyone stands to benefit.

The specification has described system and method for providing a smart calling platform for management of sales leads. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

I/We claim:

1. A method for providing a smart calling platform (104), the method comprising:
uploading, on a smart calling platform (104), a list of a plurality of executives by a business owner registered with the smart calling platform (104), wherein the list comprises details of the plurality of users that are enrolled with the business owner (102) with the intent of offering services;
allocating, by the smart calling platform (104), a unique identification to each of the plurality of executives (106) for providing authenticated access of the smart calling platform (104) to each of the plurality of executives (106);
allocating, by the smart calling platform (104), one or more potential customer (114)s to each of the plurality of executives (106), wherein the one or more potential customers (114) are allocated from a list of potential customers (114) uploaded on the smart calling platform (104) by the business owner (102), and
wherein the allocation of the one or more potential customers (114) is based on an artificial intelligence (AI) based correlation between business data associated with each of the one or more customers (114) and profile data of each of the plurality of executives (106);
monitoring, by the smart calling platform (104), one or more activities of each of the plurality of executives (106), wherein the activities comprise generation of sales leads by the plurality of executives (106); and
managing, by the smart calling platform (104), business transaction associated with the generated sales leads based on the monitoring, wherein the management comprises storing the generated sales leads and tracking maturity thereof using a maturity score.

2. The method of claim 1, wherein each of the plurality of executives (106) may register themselves with the smart calling platform (104) by providing details at the time of registration that comprise one or more of: one or more domains of expertise, experience in the one or more domains, one or more preferences relating to language, one or more preferences relating to compensation.

3. The method of claim 2, wherein the smart calling platform (104) determines a level of expertise of the registering executives in the one or more domains based on assessments, wherein the assessments comprise questions relating to the one or more domains, interviews, role-plays, and capabilities for real time call monitoring.

4. The method of claim 3, wherein the smart calling platform (104) generates an assessment score for the executives based on the assessment, and wherein basis the assessment score, the smart calling platform (104) creates a training profile for each executive for periodic re-assessment of expertise in the one or more domains.

5. The method of claim 3, wherein list of a plurality of executives (106) by a business owner (102) is generated based on application of one or more filtering criteria by the business owner (102) on at least the required domain expertise and assessment score.

6. The method of claim 1, wherein the plurality of executives (106) are authenticated based on the allocated unique identification and wherein upon successful authentication, each of the executives from the plurality of executives (106) are able to access business information of the business owner (102) and the one or more potential customers (114), for generating the sales leads.

7. The method of claim 6, wherein one or more portions of the business information are redacted for privacy and prevention of misuse.

8. The method of claim 1, wherein a pre-defined customized identity belonging to the business owner (102) is presented when an executive from the plurality of executives (106) establishes a communication channel with the one or more potential customers (114).

9. The method of claim 8, wherein the communication channel enables exchange of one or more of: telephone call, email, multimedia exchange between the customer and the executive.

10. The method of claim 1, wherein the communication channel is based on:
a first method in which an executive from the plurality of executives (106) uses the contact details of the one or more potential customers (114) for initiating the correspondence for generation of sales leads;
a second method in which an executive from the plurality of executives (106) uses the contact details of the one or more potential customers (114) for initiating the correspondence fir generation of sales leads, but the request is routed by the smart calling platform (104) to a private branch exchange;
a third method in which an executive from the plurality of executives (106) uses codes corresponding to a contact of the one or more potential customers (114),
wherein the code is transmitted by the smart calling platform (104) to a server where it is translated into actual contact details of the one or more potential customers (114) based on a pre-defined mapping between the codes and the contact details, and
wherein upon successful translation, the server establishes the communication channel between an executive a potential customer, while acting as an intermediary.

11. The method of claim 1, wherein once an executive is authenticated and is logged into the smart calling platform (104), all activities of the executive are logged on a timeline presented on a UI associated with the smart calling platform (104).

12. The method of claim 1, wherein once an executive is authenticated and is logged into the smart calling platform (104) logged in, access to one or more default functionalities of an electronic device associated with the executive are restricted.

13. The method of claim 1, further comprising transmitting the generated sales leads to a central server for analysis and insight generation by use of AI.

14. The method of claim 13, wherein the insight generation comprises determining summary of the generated sales leads, wherein the summary comprises one or more of: a probability of conversion of a sales lead, status of resolution of a grievance, and the like.

15. The method of claim 1, wherein the smart calling platform (104) enable reassignment of the generated sales leads between a plurality of business owner (102)s and/or the plurality of executives (106).

16. The method of claim 15, wherein the reassignment is based on a bid placed by business owners (102) from a plurality of business owners and/or executives from the plurality of executives (106), wherein the bid is placed based on analysis of the determined summary of the sales leads.

17. The method of claim 1, further comprising, facilitating generation of customized notifications for the business owner (102) that are triggered when the plurality of executives (106) establish a communication channel with the one or more potential customers (114), while generating sales leads for the business owner (102).

18. The method of claim 1, wherein the smart calling platform is downloaded in a mobile device of the customer, wherein the customer understands that the calls being received are verified calls and any fraudulent calls can be averted, wherein the customer is able to understand the source of a calling person, wherein the customer provides an input to block the source number based on one or more options displayed to the customer, and wherein a recording of the correspondence is provided to the customer based on a request.

19. The method of claim 1, wherein the smart calling platform generates a rating for each of the customer, executive and the business owner.

20. A smart calling platform (104) for management of sales leads, the platform comprising:
a business owner (102) registered with the platform, a plurality of executives (106) for generation of sales leads for the business owner (102), wherein for managing the generated sales leads, the smart calling platform (104) enables the business owner (102) to:
upload a list of a plurality of executives (106) registered with the smart calling platform (104), wherein the list comprises details of the plurality of users that are enrolled with the business owner (102) with the intent of offering services;
allocate a unique identification to each of the plurality of executives (106) for providing authenticated access of the smart calling platform (104) to each of the plurality of executives (106);
allocate one or more potential customers (114) to each of the plurality of executives (106), wherein the one or more potential customers (114) are allocated from a list of potential customers (114) uploaded on the smart calling platform (104) by the business owner (102), and
wherein the allocation of the one or more potential customers (114) is based on an artificial intelligence (AI) based correlation between business data associated with each of the one or more customers (114) and profile data of each of the plurality of executives (106);
monitor one or more activities of each of the plurality of executives (106), wherein the activities comprise generation of sales leads by the plurality of executives (106); and
manage business transaction associated with the generated sales leads based on the monitoring, wherein the management comprises storing the generated sales leads and tracking maturity thereof using a maturity score.
